(19) United States
(12) Patent Application Publication
(10) Pub. No.: US 2017/0154617 A1
(43) Pub. Date: Jun. 1, 2017

(54) DETECTION TERMINAL INCLUDING A PIEZOELECTRIC TRANSDUCER SECURED TO A DIAPHRAGM CONNECTED TO AN ABUTMENT STRUCTURE

(71) Applicant: IEM SA, Plan-les-Ouates (CH)

(72) Inventors: Edouard MENOUD, Plan-les-Ouates (CH); Michel DEMIERRE, Semsales (CH)

(73) Assignee: IEM SA, Plan-les-Ouates (CH)

(21) Appl. No.: 15/319,088

(22) PCT Filed: Jun. 16, 2015
(86) PCT No.: PCT/IB2015/054549

§ 371 Date: Dec. 15, 2016

(30) Foreign Application Priority Data
Jun. 18, 2014 (FR) 14/01374

(51) Int. Cl. G10K 9/22; G10K 11/00; E01F 11/00; G01S 15/04

(52) U.S. Cl. CPC G10K 9/22; G01S 15/04; G10K 11/004; E01F 11/00

(57) ABSTRACT

A detection terminal including a piezoelectric transducer emitting and receiving ultrasound waves via a diaphragm to which it is secured, said diaphragm being arranged opposite an opening of a housing and connected to said housing by connection mechanism. According to the invention, the diaphragm is connected to a rigid structure which enables same, when subjected to pressure, to undergo a contraction limited to the space provided for said purpose, in the opening of the housing, determined by a position of the structure abutting against a surface of the housing opposite the opening.

The invention relates to a terminal for detecting parked vehicles to monitor respect of parking rights and/or acting as basic elements used by the vehicle guiding devices.

Over the last few years, independent vehicle detection terminals embedded on the roadway have appeared on the market, which transmit the occupation information by radio to a manager device. Initially, these terminals used the earth's magnetic field variations generated by vehicles as detection criterion. However, the reliability of this technology is limited, about 95% when the parking spaces are angled or when large vehicles such as buses or lorries are parked near the parking space being monitored and becomes highly random when the terminal is near tram, underground train or power supply lines.

To overcome these disadvantages, manufacturers have considered replacing or completing magnetic detection with a second criterion generally based on an optical or sound measurement. Document WO 06005208 describes a detector used to detect the presence of a vehicle through the use of a second complementary technology based on an infrared laser or ultrasound wave rangefinder.

Thus, equipped with this type of detection, reliability exceeds 99% when the detector is not disturbed by water or snow.

Judiciously, combining the magnetic technology with the optical or sound technology yields a reliability rate of over 99% in dry weather and about 95% when a disturbing factor such as snow is present.

The magnetic technology allows the detector to be buried in the roadway, while with optical or sound technologies, a sensitive part of the detector acting as interface between the buried part of the detector and the air must be able to transmit optical or acoustic radiation towards the vehicle to be detected and receive the reflected radiation. This sensitive part may consist of one or more small windows for optical detectors or one or more vibrating surfaces or diaphragms for the sound detectors.

Document DE 199 37 195 discloses detection means comprising a piezoelectric transducer transmitting and receiving ultrasound waves via a diaphragm to which it is secured, said diaphragm being arranged opposite an opening of a box and connected to said box by connecting means.

The detection means known by this document is intended to be installed in a vehicle bumper. It is not suitable for a detection terminal, which is subjected to severe stresses during the passage of vehicle wheels, or during the passage of a snowplough blade especially in areas where parking is alternated every day from one side of the road to another in order to clear the snow.

The contribution of the invention consists in introducing retraction means to allow the passage of vehicle wheels or of a snowplough blade.

The invention therefore relates to a detection terminal according to the above outline, characterised in that the diaphragm is connected to a structure allowing it, when it is subjected to a pressure, to retract into the opening of the box, determined by a position of the structure in abutment against a surface of the box opposite the opening.

The abutment position of the structure limits the deformation of the connecting means to what is necessary to retract the diaphragm. In this retracted position, the pressure exerted on the diaphragm is taken up by the box. The piezoelectric transducer is therefore protected from the passage of a vehicle over the detection terminal, without the need to create raised sections in the box.

According to a first embodiment, the structure is tubular while the connecting means comprise an elastomer seal.

According to a second embodiment, the structure is tubular while the connecting means comprise a skirt which forms a single part with the diaphragm.

According to a third embodiment, the connecting means comprise a skirt which forms a single part with the diaphragm while the structure comprises a rib formed in a thickness of the skirt by first and second thinnings of material.

The sensitive surface, i.e. the diaphragm to which the piezoelectric transducer is secured, is advantageously located on the ground or flush with the roadway or the parking space, and goes down, i.e. takes the retracted position when subjected to a pressure generated by a tyre or a brush, to protect said surface.

Advantageously, the structure and the box are provided with reciprocal means blocking them in rotation with respect to each other. Thus, the detection terminal will also withstand the rotational forces of a wheel located on top of it, said wheel possibly being subjected to a powerful and malicious action from a driver using his vehicle's power steering to destroy the detector.

The measurement method implemented is that of an ultrasound rangefinder measuring the distance to the closest point contained within an observation cone.

The following figures show, as non-limiting examples, some embodiments.

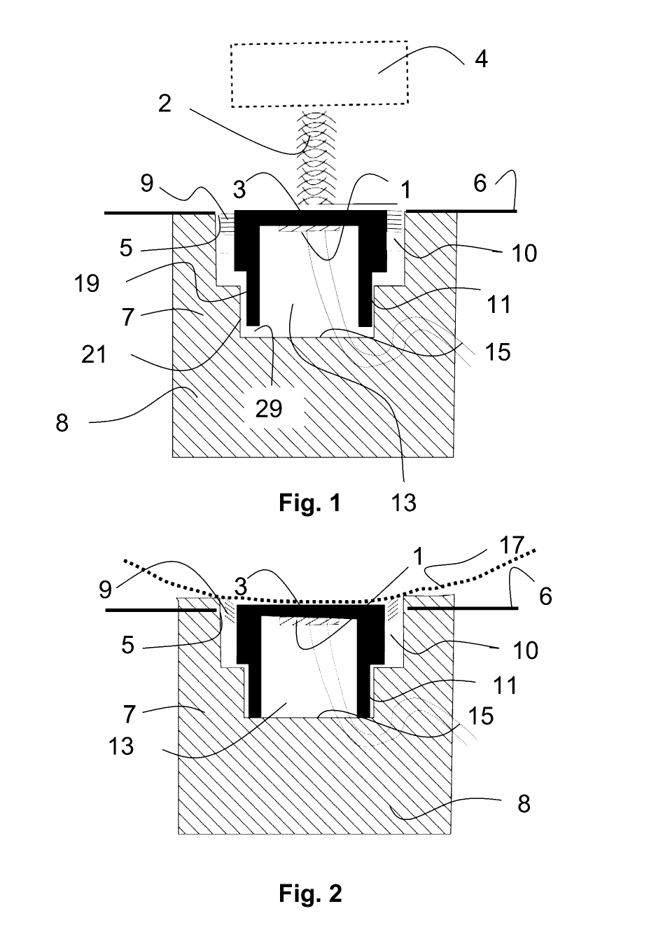

FIG. 1 shows a detection terminal flush with the ground according to the first embodiment.

FIG. 2 shows the detection terminal of FIG. 1 subjected to the pressure of a vehicle tyre.

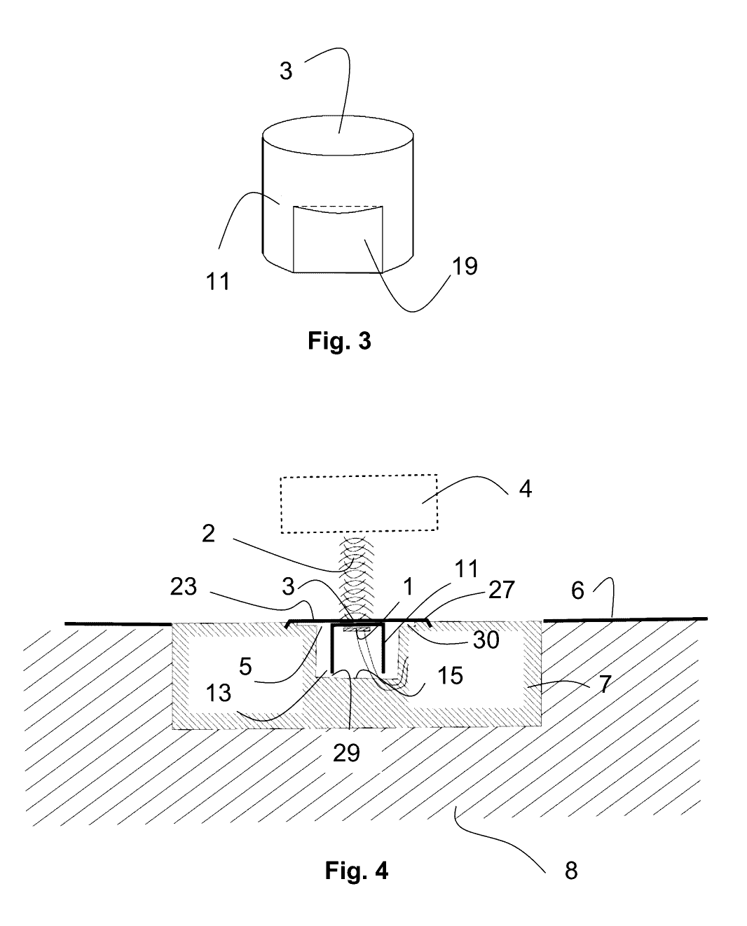

FIG. 3 shows in perspective the support of the diaphragm of the detection terminal illustrated by the previous figures.

FIG. 4 shows a detection terminal flush with the ground according to the second embodiment.

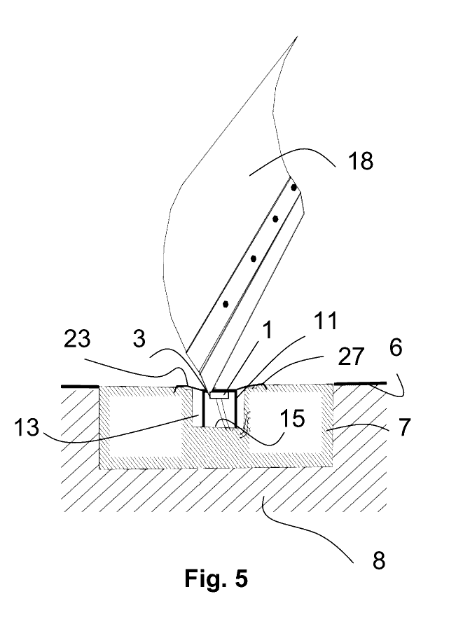

FIG. 5 shows the detection terminal of FIG. 4 subjected to the pressure of a snowplough blade.

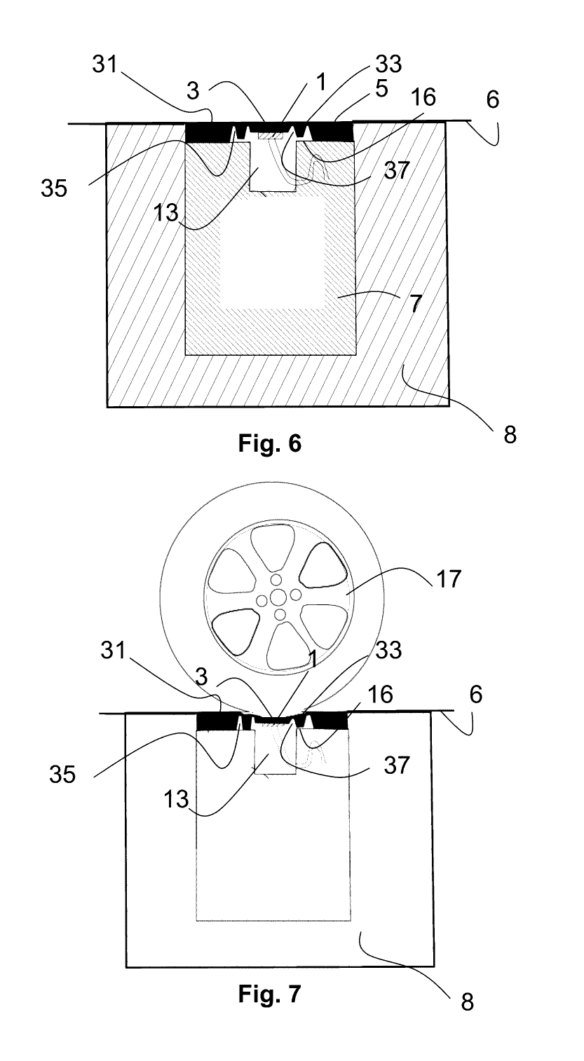

FIG. 6 shows a detection terminal flush with the ground according to the third embodiment.

FIG. 7 shows the detection terminal of FIG. 6 subjected to the pressure of a vehicle tyre.

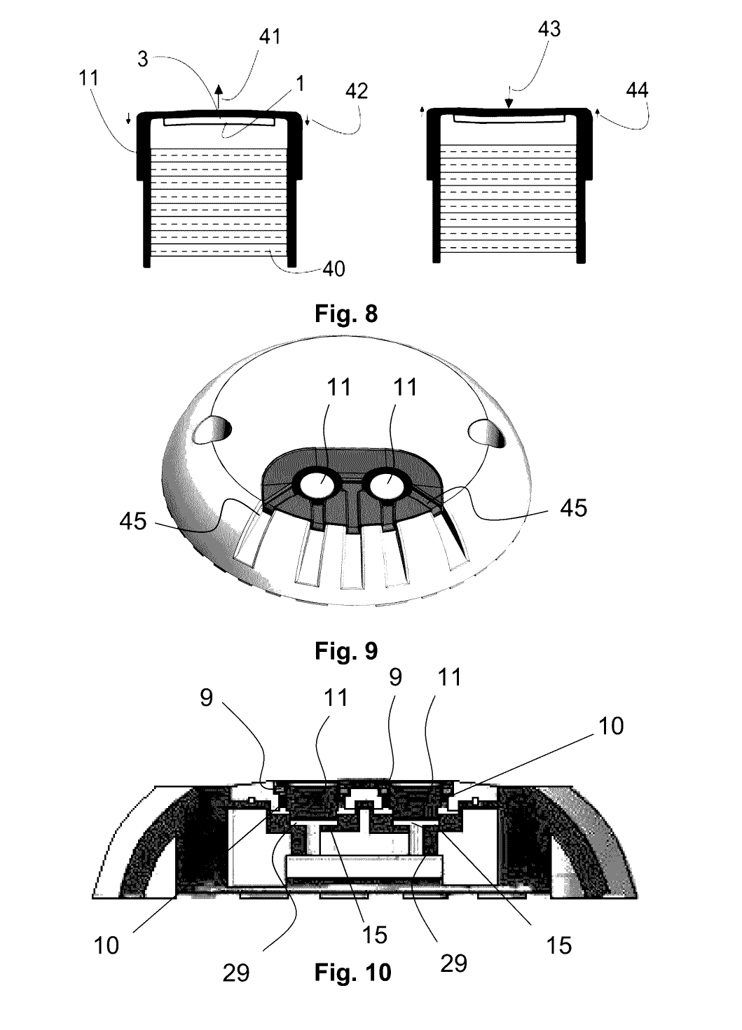

FIG. 8 shows the effect of ultrasound bending on the structure of the first embodiment.

FIG. 9 shows a complete bi-sensor detection terminal according to the first embodiment.

FIG. 10 shows a cross-section of the bi-sensor terminal according to the first embodiment.

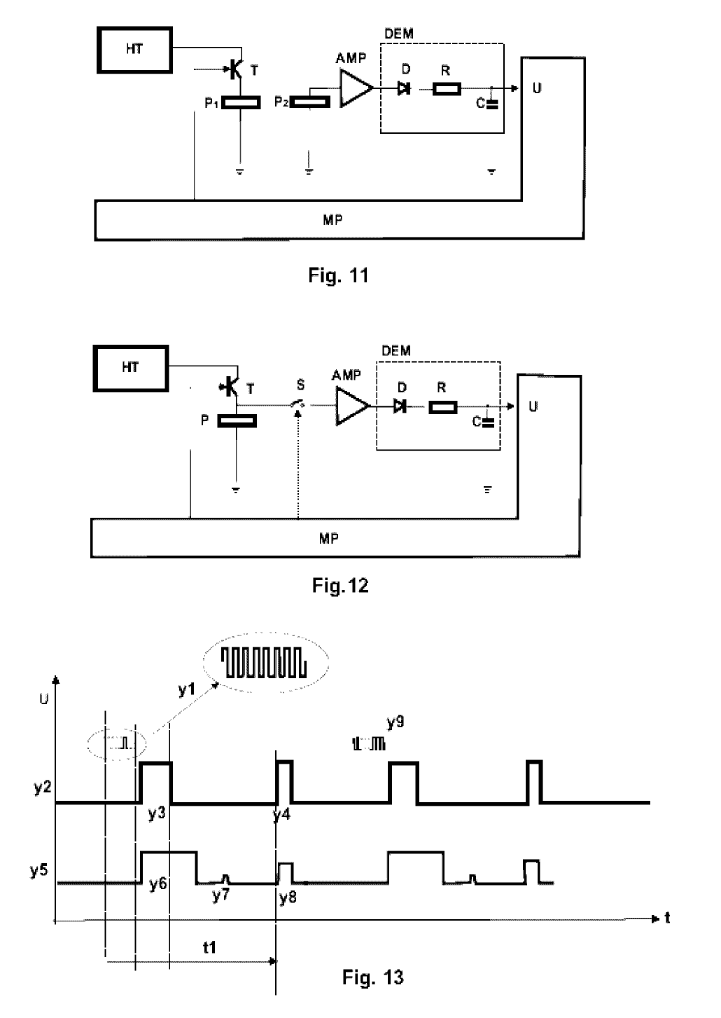

FIG. 11 shows the wiring diagram of a bi-sensor terminal.

FIG. 12 shows the wiring diagram of a mono-sensor terminal.

FIG. 13 shows the relevant electrical signals of a terminal.

A detection terminal according to the first embodiment comprises, FIG. 1, a piezoelectric transducer 1 transmitting and receiving ultrasound waves 2 via a diaphragm 3 to which it is secured, for example by gluing. Said diaphragm 3 is housed in an opening 5 of an outer box 7 buried in the ground 8. In this arrangement, the diaphragm 3 is level with the surface 6 of the ground.

The box 7 houses various electronic components, not shown, such as a microprocessor, a possible magnetic sensor, a battery and a radio antenna.

FIG. 8 provides an exaggerated view of the ultrasonic wave generation and reception mechanism. It shows the piezoelectric transducer and its diaphragm 3 secured (glued) on the structure 11. The left hand figure shows the diaphragm in positive bending, i.e. with an elevation of the centre 41, the elevation being transferred to the top of the structure 41. Due to a counter-reaction effect (conservation of momentum), the side walls undergo a vertical downward micro-movement 42. The left hand figure shows the opposite phase, i.e. negative bending of the diaphragm generating a lowering of the top of the structure 43 and its compensatory effect which is a vertical upward micro-movement of the walls of the structure 44. During the transmission of sounds, the movements generated by the piezoelectric element and transferred to the structure are of the order of the micrometre, while they are two to three orders of magnitude less during reception. The inside of the structure is filled with isophonic “sound insulating” foam to block reflections which could come from the back of the structure connected to the box 7 by an elastomer seal 9 and connected to a structure 11. Said seal 9 has an annular shape and is glued to the box 7 by a bead of glue 10. The structure 11 has a tubular shape and is inserted in a housing 13 of the box 7 which is also cylindrical. Said housing 13 extends between the opening 5 and an opposite bottom 15. The tubular structure 11 extends in the housing 13 to less than a fraction of a millimetre above the bottom 15. The diaphragm 3 and the tubular structure 11 may form a single part.

During operation, the diaphragm 3 forms an oscillating surface excited by the piezoelectric transducer 1. The assembly is impedance-matched with the structure 11. The ultrasound wave train 2 is sent to a target 4, for example a vehicle sump, and reflected towards the diaphragm 3. This technique provides a wide observation area, of conical shape. It also allows the distance between the ground and the target to be determined.

As illustrated on FIG. 2, the elastomer seal 9 allows the diaphragm 3 to retract when it is subjected to a pressure, for example from a vehicle tyre 17 rolling over the detection terminal. The retraction is determined by the position of the structure 11 for which it is in abutment against the bottom 15 of the housing 13 formed in the box 7. The structure 11 therefore has a gap 29 of the order of a few tenths of a millimetre with respect to the bottom 15 of the housing 13.

FIGS. 1 and 3, the structure 11 and the housing 13 each have a flat 19, 21 blocking them in rotation with respect to each other. This arrangement provides better protection of the piezoelectric transducer 1 and the elastomer seal 9 against a malicious action of a driver who would use his vehicle's power steering to try to destroy the detection terminal.

In the embodiment example illustrated on FIGS. 4 and 5, the detection terminal is also flush with the ground 6. The piezoelectric transducer 1 is secured to the diaphragm 3 which is connected to the structure 11 by an isophonic “sound insulating” connection favourable to vertical sound micro-movements. The connecting means comprise a skirt 23 which forms a single part, which may be metallic, with the diaphragm 3. Said part closes the opening 5 of the housing 13 by being secured to the box by attachment points 27.

A gap 30 of the order of a tenth of a millimetre allows the skirt 23 and the diaphragm 3 to vibrate when transmitting and receiving ultrasounds. The structure 11 transfers to the box 7 the pressure which is exerted on the diaphragm 3 when a vehicle drives over the detection terminal. Once again, the structure 11 has a gap of the order of a few tenths of a millimetre with respect to the bottom 15 of the housing 13.

FIG. 5 shows the retraction of the diaphragm 3 in the opening 5 of the box 7, when it is subjected to the pressure of a snowplough blade 18. The structure 11 is in abutment against the bottom 15 of the housing 13.

In the embodiment illustrated by FIGS. 6 and 7, the detection terminal is once again flush with the ground 6. The connecting means comprise a skirt 31 which forms a single part with the diaphragm 3 arranged so as to insulate the vertical micro-movements, while the structure 11 comprises a rib 33 formed in the thickness of the skirt by first 35 and second 37 thinnings of material. Said thinnings or notches secure the vibrating areas precisely with respect to the fixed areas and thereby perfectly control the mechanical impedance of the vibrating diaphragm 3.

FIG. 6, once again, the structure 33 has a gap of the order of a few tenths of a millimetre with respect to the surface 16 of the housing 13.

FIG. 7 shows the retraction of the diaphragm 3 in the opening 5 of the box 7, when it is subjected to the pressure of a tyre 17. The structure 11 is in abutment against the surface 16 of the housing 13.

FIGS. 9 to 13 show an above-ground terminal embodiment, in more detail.

FIG. 9 shows an above-ground terminal of diameter 18 cm and height 2.5 cm with two ultrasound sensors integrated in structures embedded in the terminal profile and positioned slightly obliquely to evacuate water. It also shows grooves 45 intended to facilitate evacuation of water while taking off the structures 11 some of the load resulting from the presence of a wheel on the structure.

FIG. 10 shows a cross-section of the ultrasound sensors of the terminal shown on FIG. 9. The structures 11 have a diameter of 14 mm and a height of 10 mm. They are secured to the box by a first highly flexible, 2 mm thick seal 9 (hardness less than 20 Sh) and an MS-polymer based elastic glue 10 which is also highly flexible applied at the back of the box in a subsequent operation. This assembly therefore allows vertical micro-movements which are not transmitted to the box. This figure also shows the gap 29 of the order of a few tenths of a millimetre with respect to the bottom 15 of the housing.

FIGS. 11 to 13 explain the basic operation of ultrasound detection in order to demonstrate the need to phonically insulate the ultrasound device from the box. The measurement principle consists in periodically sending, to the piezoelectric element, a pulse train comprising a few cycles whose frequency corresponds to the resonance frequency of the piezoelectric element. One of the applications implemented comprises trains of 8 pulses sent at the frequency of 40 kHz. The second part of the principle consists in measuring the reflected wave, then in measuring the time between transmission of the train, then arrival of the reflected wave, this time being proportional to the distance between the piezoelectric element and the target.

The assembly of FIG. 11 shows a bi-sensor device. It includes a microprocessor MP, a high-voltage source HT of about 100 V, a transistor T controlled by the microprocessor and used to send the wave train y1 to the transmitting piezoelectric element P1. The reflected wave is detected by the receiving piezoelectric element P2. The signal is amplified AMP then demodulated by a demodulator DEM composed of elements D, R and C before being sent to an analogue input U of the microprocessor. The assembly of FIG. 12 shows a mono-sensor device. It is similar to the bi-sensor assembly, except that there is only one piezoelectric element P assembled in a similar structure. This element is used to transmit the pulses before being switched to the amplifier by means of the switch S at the end of transmission. The difference between the two assemblies lies in the fact that with double detection, the phonic insulation is improved and consequently, the blinding zone is more reduced. This blinding can also be reduced by an order of magnitude by working at 400 kHz rather than 40 kHz, but this also limits the measurement distance which becomes critical for the detection of lorries.

FIG. 13 shows the wave train y1 sent periodically then the response at the output of the demodulator U. In the first case y2, the sensor is secured to the box by a suitable seal-glue assembly. The figure shows the blinding zone y3 then after a time t1 the response y4 related to the reflection of the wave on the target. In the second case y5, the sensor is secured to the box by a traditional seal-glue assembly (hardness greater than 40 Sh). We therefore see that the blinding zone y6 is larger and that there are some internal reflections or phantom reflections y7 where the transmitted wave crosses the seal-glue area then strikes the edges of the box to return to the detector, and finally we see the required reflection y8 which appears with a lower amplitude then the next start of the new wave train y9.

1-5. (canceled)

6. A detection terminal comprising:
a piezoelectric transducer transmitting and receiving ultrasound waves via a diaphragm to which it is secured, said diaphragm being arranged opposite an opening of a box and connected to said box by isophonic “sound insulating” connecting mechanism, wherein the diaphragm is connected to a rigid structure allowing it, when it is subjected to a pressure, to retract, by a distance limited to a gap, into the opening of the box, determined by a position of the structure in abutment against a surface of the box opposite the opening.

7. The detection terminal according to claim 6, wherein the structure is tubular and rigid while the connecting mechanism comprise an isophonic elastomer seal.

8. The detection terminal according to claim 6, wherein the structure is tubular while the connecting mechanism comprise a skirt which has a connection, with the box, which is isophonic to the vertical waves and forms a single part with the diaphragm.

9. The detection terminal according to claim 7, wherein the structure and the box are provided with reciprocal mechanism blocking them in rotation with respect to each other.

10. The detection terminal according to claim 6, wherein the connecting mechanism comprise a skirt which forms a single part with the diaphragm while the structure comprises a rib formed in a thickness of the skirt by first and second thinnings of material arranged to create a connection, with the box, which is isophonic to the vertical waves.
